(19) United States
(12) Patent Application Publication
(10) Pub. No.: US 2002/0039514 A1
(43) Pub. Date: Apr. 4, 2002

(54) Writing apparatus with incorporated light

(76) Inventor: Lorens Tuynman, Bellflower, CA (US)

Correspondence Address: Matthew J. Peirce, Esq., 1550 Starlight Canyon Avenue, Las Vegas, NV, 89123, US

(21) Appl. No.: 09/970,469

(22) Filed: Oct. 3, 2001

Related U.S. Application Data
(60) Provisional application No. 60/237,126, filed on Oct. 3, 2000.

(51) Int. Cl. B43K 29/00

(52) U.S. Cl. 401/195

(57) ABSTRACT

A ballpoint pen is disclosed wherein the pen has an incorporated light attached to the writing end of the pen. The incorporated light would be connected to a battery, which would be located inside the pen. When a user would push down on the end-mounted button on the pen, the button would also act as an on/off switch and would activate the light. The light would only be activated when the ballpoint would be sticking out and ready to be used.

### I. BACKGROUND OF THE INVENTION

The present invention is that of a new and improved ballpoint pen, and more particularly relates to that of a ballpoint pen that has an incorporated light attached to the writing end of the pen.

### II. DESCRIPTION OF THE PRIOR ART

U.S. Pat. No. 4,890,204, issued to Lin et al., discloses a ballpoint pen with self-illumination and comprises a writing device and an illuminating device coupled together by a screw joint.

U.S. Pat. No. 3,045,111, issued to Hoenig, discloses a pen construction and particularly to a ballpoint pen construction having self-contained electrical illuminating means.

### III. SUMMARY OF THE INVENTION

The present invention is that of a new and improved ballpoint pen, and more particularly relates to that of a ballpoint pen that has an incorporated light attached to the writing end of the pen. The incorporated light would be connected to a battery, which would be located inside the pen. When a user would push down on the end-mounted button on the pen, the button would also act as an on/off switch and would activate the light. The light would only be activated when the ballpoint would be sticking out and ready to be used.

There has thus been outlined, rather broadly, the more important features of a ballpoint pen in order that the detailed description thereof that follows may be better understood and in order that the present contribution to the art may be better appreciated. There are, of course, additional features of the ballpoint pen that will be described hereinafter and which will form the subject matter of the claims appended hereto.

In this respect, before explaining at least one embodiment of the ballpoint pen in detail, it is to be understood that the ballpoint pen is not limited in its application to the details of construction and to the arrangements of the components set forth in the following description or illustrated in the drawings. The ballpoint pen is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present ballpoint pen. It is important, therefore, that the claims be regard as including such equivalent constructions insofar as they do not depart from the spirit and scope of the present invention.

It is therefore an object of the present invention to provide a ballpoint pen which has all of the advantages of the prior art and none of the disadvantages.

It is another object of the present invention to provide a ballpoint pen which may be easily and efficiently manufactured and marketed.

It is another object of the present invention to provide a ballpoint pen which is of durable and reliable construction.

It is yet another object of the present invention to provide a ballpoint pen which is economically affordable and available to the buying public.

It is yet another object of the present invention to provide a ballpoint pen which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIGS. 1 and 2 show perspective views of the present invention with various types of batteries that would be located inside the pen.

FIG. 3 shows a close-up perspective view of the front portion of the pen.

FIG. 4 shows the present invention in use.

### V. DESCRIPTION OF THE PREFERRED EMBODIMENT

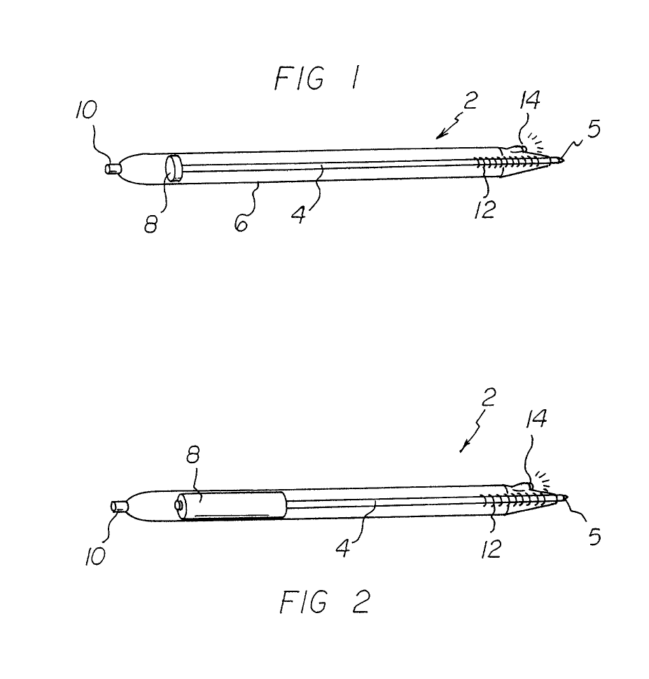

FIGS. 1 and 2 show perspective views of the present invention with various types of batteries that would be located inside the pen 2. Pen 2 can be seen with ink cartridge 4, outer casing 6, battery 8, and end-mounted button 10. In addition, spring 12 and light 14 can be seen. Cartridge 4 has an end-mounted ballpoint 5 which would allow a user to use pen 2 to properly write.

When a user would push down on the end-mounted button 10 on the pen 2, the button 10 would also act as an on/off switch and would activate the light 14. The light 14 would only be activated when the ballpoint 5 would be sticking out of outer cashing 6 of pen 2 and ready to be used. A user could turn off light 14 and allow ballpoint 5 to be placed back within outer casing 6 by pushing down on button 10 once.

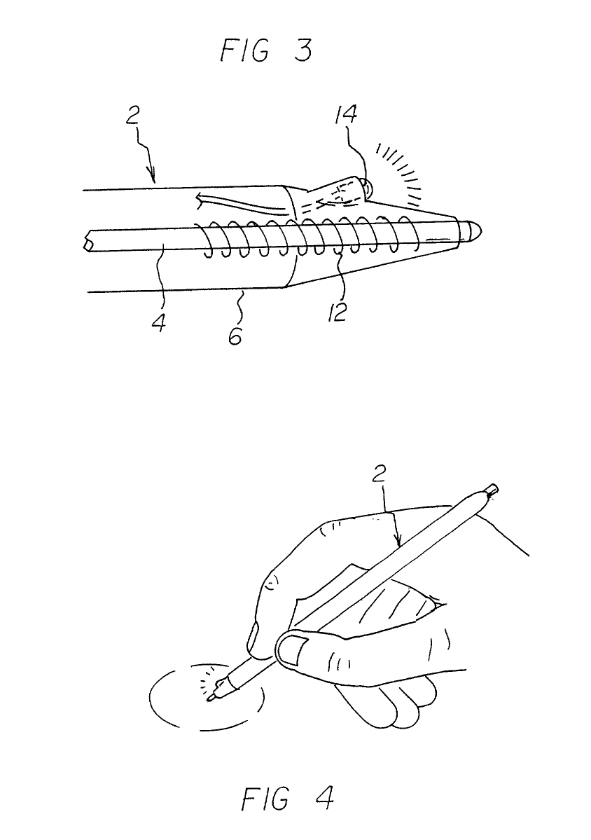

FIG. 3 shows a close-up perspective view of the front portion of the pen 2. Cartridge 4, outer casing 6, spring 12, and light 14 can be seen. As can be seen, light 14 is attached to the side of pen 2 and emits light in a forward manner once activated. Light 14 is electronically connected to battery 8 by a wire or other electronic means located within pen 2.

FIG. 4 shows the present invention in use.

What I claim as my invention is:

1. A writing apparatus comprising:
(a) an outer casing having two ends, a first end and a second end, the first end of the outer casing having a small opening,
(b) an ink cartridge, the ink cartridge having a cylindrical shape, the ink cartridge having two ends, a first end and a second end, the first end of the ink cartridge including a ballpoint,
(c) a spring attached to the ink cartridge,
(d) a push button attached to the second end of the outer casing,
(e) a light attached to the outer casing near the first end of the outer casing, and
(f) power means for providing power to the light, the power means being electronically connected to the light.

2. A writing apparatus according to claim 1 wherein the power means for providing power to the light would comprise a battery located within the outer casing.

3. A writing apparatus according to claim 2 wherein the ink cartridge could be set in one of two possible positions, a first position and a second position, wherein the ink cartridge would be completely located within the outer casing when the ink cartridge would be in the first position, further wherein the first end of the ink cartridge would be slightly extended through the hole on the first end of the outer casing when the ink cartridge would be in the second position, and further wherein the ink cartridge would be movable from one position to the other position through the depression of the push button.

4. A writing apparatus according to claim 3 wherein the light would be on when the ink cartridge would be in the second position.

5. A writing apparatus according to claim 3 wherein the light would be off when the ink cartridge would be in the first position.

6. A writing apparatus according to claim 3 wherein the push button would act as a switch for the light upon the depression of the push button.
